(19) United States
(12) Patent Application Publication
(10) Pub. No.: US 2025/0144937 A1
(43) Pub. Date: May 8, 2025

(54) PRINT HEAD MANAGEMENT ACCESSORIES

(71) Applicant: Kateeva, Inc., Newark, CA (US)

(72) Inventor: Alexander Sou-Kang Ko, Newark, CA (US)

(73) Assignee: Kateeva, Inc., Newark, CA (US)

(21) Appl. No.: 18/838,374

(22) PCT Filed: Feb. 16, 2023
(86) PCT No.: PCT/US2023/062699

§ 371 Date: Aug. 14, 2024

Related U.S. Application Data
(60) Provisional application No. 63/268,360, filed on Feb. 22, 2022.

(51) Int. Cl. B41J 2/165; B41J 3/54

(52) U.S. Cl. CPC B41J 2/1652; B41J 2/16579; B41J 3/543; B41J 2002/16573

(57) ABSTRACT

Embodiments of inkjet printers, and methods of operating inkjet printers, are described herein. The inkjet printers include a substrate support a print support comprising a printhead assembly movably coupled to a printhead assembly support disposed across the substrate support, and a printhead management unit comprising a first printhead cleaner having a first areal extent and a second printhead cleaner having a second areal extent different from the first areal extent. The first and second printhead cleaner can be used in cleaning processes to optimize the cleaning process.

### BACKGROUND

Industrial inkjet printers are used to apply materials to large substrates to form devices of all kinds. A liquid material is dispensed through a print head onto a substrate, and is then typically fixated to the substrate by hardening, drying, curing, or other process. The print head features a large number of nozzles for dispensing the liquid, and recent development has seen assemblies with large numbers of print heads, each with a large number of nozzles, resulting in print head assemblies with tens of thousands of print nozzles.

The nozzles can be fouled by print material collecting, and sometimes solidifying, at and around the nozzles. Such deposits can change the operation of individual nozzles or make them inoperable. Cleaning tools are conventionally used to remove such deposits, but there is always a need for faster and better cleaning tools to reduce the time needed to perform print head maintenance.

### SUMMARY

Embodiments described herein provide an inkjet printer that includes a substrate support; a print support comprising a printhead assembly movably coupled to a printhead assembly support disposed across the substrate support; and a printhead management unit comprising a first printhead cleaner having a first areal extent and a second printhead cleaner having a second areal extent different from the first areal extent.

Other embodiments described herein provide a method of operating an inkjet printer by testing ejection of droplets of print material from nozzles of a plurality of printheads of the inkjet printer, the printheads arranged in tiles, each tile having a plurality of printheads; determining, from the testing, any tiles that need cleaning; defining a cleaning process comprising using a single-group cleaner of the inkjet printer, a multi-group cleaner of the inkjet printer, or both to clean the tiles; and using the single-group cleaner, the multi-group cleaner, or both according to the cleaning process.

### BRIEF DESCRIPTION OF THE FIGURES

FIG. 1 is a plan view of an inkjet printer according to one embodiment.

FIG. 2 is a schematic plan view of the printhead management unit of FIG. 1.

FIG. 3A is a schematic view of a printhead management unit according to another embodiment.

FIG. 3B is a schematic elevation view of a printhead cleaner according to one embodiment.

FIG. 4 is an activity diagram illustrating a use of the cleaning unit of FIG. 3A to clean printhead groups of the printhead assembly of FIG. 1, according to one embodiment.

FIGS. 5-7 are flow diagrams summarizing method embodiments.

### DETAILED DESCRIPTION

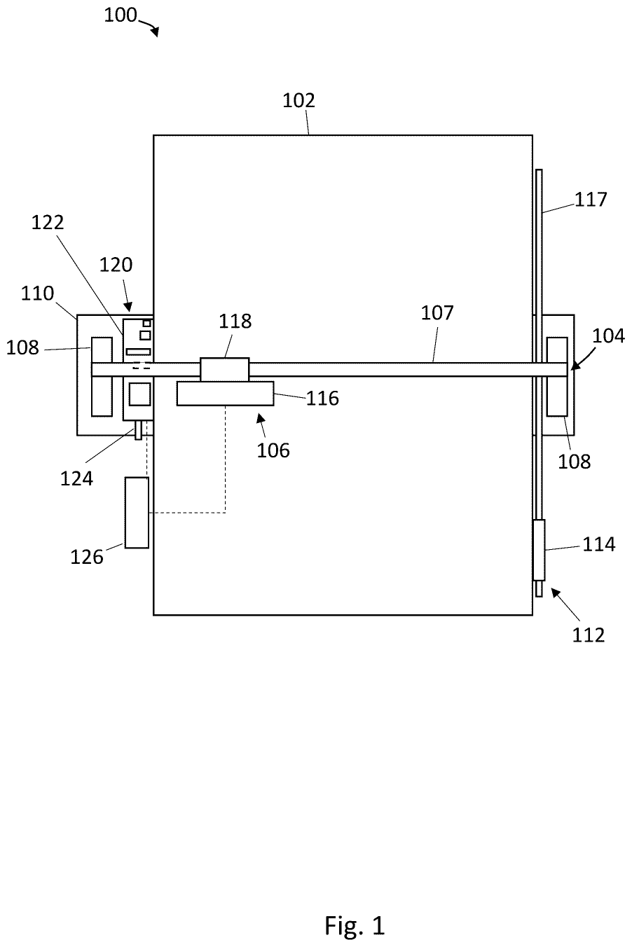

An inkjet printer is described herein that has a print head management station with at least two cleaning tools with different footprints that can be used to optimize print head maintenance. FIG. 1 is a plan view of an inkjet printer 100, according to one embodiment. The inkjet printer 100 has a substrate support 102 that supports a substrate for processing by the printer 100. A print support 104 is positioned to support a printhead assembly 106 for dispensing print material onto a substrate supported by the substrate support 102. The print support 104 includes a printhead assembly support 107 disposed across the substrate support 102 and supported by two stands 108, one on either opposite side of the substrate support 102. The substrate support 102 and print support 104 both rest on a base 110, which is a massive object that minimizes transmission of ambient movement to the substrate support 102 and the print support 104.

On one side of the substrate support 102 is a holder assembly 112 that engages with a substrate supported by the substrate support 102 to hold and transport the substrate for processing by the printer 100. The holder assembly 112 features a substrate holder 114 that travels along a holder support 117 to move the substrate in the longitudinal direction of the printer 100. The printhead assembly 106 moves along the printhead assembly support 107 in the transverse direction of the printer 100. Relative movement of the printhead assembly 106 and the holder 114 enables processing of all desired locations of the substrate.

The printhead assembly 106 has a printhead housing 116, which houses one or more printheads (not visible) that face the substrate support 102 to dispense print material toward the substrate support 102. The printhead housing 116 is connected to a movement unit 118 that engages with the printhead assembly support 107 to move the printhead housing 116 along the printhead assembly support 107 in the transverse direction. The movement unit 118, in this case, extends over the printhead assembly support 107 and supports the printhead housing 116 by resting on or above the printhead assembly support 107. In one embodiment, the movement unit 118 includes a gas support to form a gas cushion between the movement unit 118 and the printhead assembly support 107 to provide frictionless motion along the printhead assembly support 107.

On a side of the substrate support 102 opposite from the holder assembly 112 side is a printhead management unit 120. The printhead management unit 120 includes a plurality of tools for performing diagnostic and maintenance procedures on print nozzles of one or more printheads. Each printhead has a plurality of print nozzles that dispense print material. The print nozzles are usually arranged in a linear configuration, sometimes in multiple rows for each printhead. In many cases, a plurality of printheads are arranged in a tile, and the printhead housing houses a plurality of printhead groups, each having a plurality of printheads with multiple print nozzles. Thus, the number of nozzles can run into many thousands for some printhead assemblies.

The tools of the printhead management unit 120 are generally disposed on a tool base 122, a platform in this case, which in turn is disposed on a station support 124 that allows the printhead management unit 120 to move in the longitudinal direction of the printer 100 to position different tools to operate on the printhead assembly 106. The holder assembly 112 and the printhead management unit 120 are both disposed on the base 110 between the two stands 108. The holder support 117 and the station support 124 may extend beyond the base 110 to provide range of motion for the holder 114 and the printhead management unit 120. Where necessary, floor supports (not visible) can be provided for the holder support 117 and the station support 124.

A controller 126 can be operatively coupled to the printhead assembly 106 and the printhead management unit 120 to control operations of the two components. The controller 126 can be configured to move the printhead assembly to a position for engagement with the printhead management unit 120 and to move the printhead management unit 120 to one or more positions for engagement with the printhead assembly 106. Both the printhead assembly 106 and the printhead management unit 120 can be moved to positions convenient for performing maintenance or diagnostic operations on the printhead assembly 106 using any of the tools of the printhead management unit 120. The controller 126 has a digital processing system that can be configured to perform any of the operations of the methods described herein.

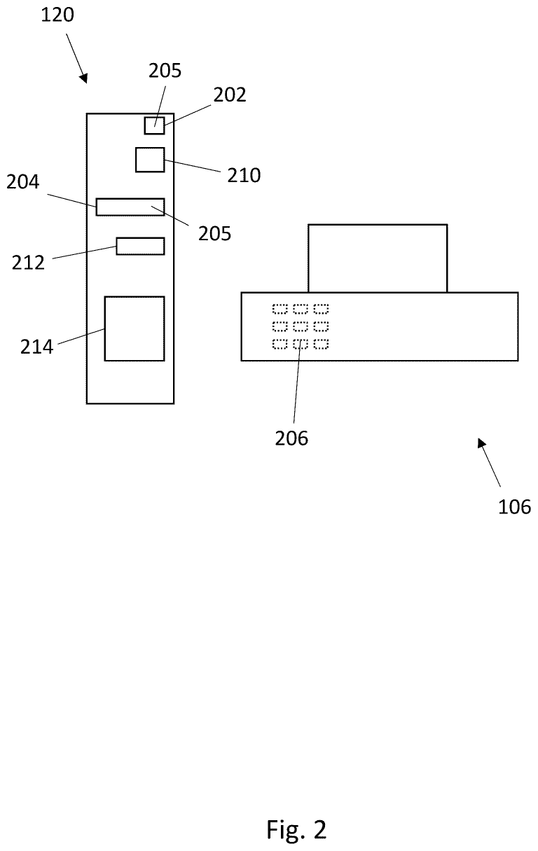

FIG. 2 is a schematic plan view of the printhead management unit 120. The printhead assembly 106 is also shown for reference and comparison. Among the tools of the printhead management unit 120 are two printhead cleaners, a first printhead cleaner 202 and a second printhead cleaner 204. Each of the two printhead cleaners has a cleaning surface 205 configured to make contact with a nozzle surface of a printhead or printhead group and remove deposits on the nozzle surface.

The two printhead cleaners 202 and 204 have different sizes. The first printhead cleaner 202 has a first size with a first areal extent and the second printhead cleaner 204 has a second size different from the first size, with a second areal extent different from the first areal extent. The first areal extent is large enough to clean one printhead group. As noted above, the printheads can be arranged in printhead groups. Printhead groups 206 are shown here in phantom for the printhead assembly 106. The printhead groups 206 are at a lower surface of the printhead assembly 106, are visible from the bottom of the printhead assembly 106, and are not visible in the views of FIGS. 1 and 2. The printhead groups 206 are shown arranged in aligned rows and columns here to facilitate explanation. The printhead groups 206 can be arranged in aligned rows, as shown here, in staggered rows, or in arrangements that do not have rows or columns. In one arrangement not shown here, the printhead groups 206 are in rows that are half-pitch staggered. Where the printhead groups 206 are arranged in rows, the rows can have the same number of printhead groups, as shown here, or different numbers of printhead groups. In one arrangement not shown here, there are two groups of rows that alternate, the two groups of rows having different numbers of printhead groups, and the groups of rows being arranged in half-pitch staggered format.

Each printhead group has a nozzle surface, or plurality of nozzle surfaces, that covers an areal extent. Specifically, the nozzle surfaces of each printhead group 206 define a dispensing surface from which ink is dispensed. The nozzles of each printhead are formed in a nozzle surface of the printhead, and the nozzle surfaces of the printhead define the nozzle surface, or nozzle surfaces, of the printhead group. The nozzle surface or surfaces of a printhead group have a third areal extent, which is the areal extent of the region bounded by the smallest boundary around the nozzle surfaces of the printheads of the printhead group. The nozzle surface of the printhead group may be coextensive with the dispensing surface of the printhead group, or smaller than the dispensing surface of the printhead group. The first size of the first printhead cleaner 202 is large enough to clean the nozzle surface of one of the printhead groups 206. The first size can have an areal extent larger than the areal extent of the dispensing surface of the printhead group 206, or the first size can have an areal extent larger than the third areal extent. The second size of the second printhead cleaner 204 is larger than the first size, and is large enough to clean at least two of the printhead groups 206 simultaneously. Thus, the second size has a second areal extent that is large enough to cover the nozzle surfaces of two printhead groups, which may be adjacent. Two adjacent printhead groups have a fourth areal extent, which is the area of a region bounded by a smallest boundary around the nozzle surfaces of the two adjacent printhead groups. The second areal extent may be larger than the fourth areal extent, and may be larger than an area encompassing the dispensing surfaces of the two printhead groups. Indeed, the second areal extent may be large enough to encompass the area of three or more printhead groups. Thus, the first printhead cleaner 202 is a single-group cleaner while the second printhead cleaner 204 is a multi-group cleaner.

In one case, the second printhead cleaner 204 has a second size that is sufficient to clean one row of printhead groups simultaneously. Here, that amounts to a size larger than three printhead groups arranged in a row. In another case, the printhead groups are arranged in rows having four or five tiles each, each tile corresponding to one printhead group, so the second size is larger than four or five printhead groups arranged in a row. The second size can cover printhead groups in more than one row. For example, a square printhead cleaner could simultaneously clean four printhead groups arranged within the area of a square. Use of two printhead cleaners having different sizes, one about the size of one printhead group and another large enough for a plurality of printhead groups, allows optimization of printhead group cleaning based on detecting which printhead groups need cleaning. In FIG. 2, the two printhead cleaners 202 and 204 are spaced apart on the printhead management unit 120, so the first or second printhead cleaner 202/204 can be selected by positioning the printhead assembly 106 to use either cleaner. In other embodiments, the first and second printhead cleaners 202 and 204 can be adjacent.

Other tools of the printhead management unit 120 include a droplet deposition analyzer 210, a droplet flight analyzer 212, and a purge tool 214. The deposition analyzer 210 has a test substrate for depositing droplets of print material from one of the printhead groups 206, and an imaging system can be located with the deposition analyzer 210 or elsewhere, for example attached to the printhead assembly 106, to determine characteristics of the deposited droplets. The characteristics are related to the nozzle and waveform that deposited the droplet, and are stored in a memory for use by a print controller to plan deposition of print material on a production substrate. The droplet flight analyzer 212 uses a light source and imaging system, separate from the imaging system used with the droplet deposition analyzer 210, to capture images of droplets dispensed from nozzles of the printhead assembly 106 in flight. The images can be used, among other things, to determine droplet size and trajectory. As with the droplet deposition analyzer 210, the droplet size and trajectory are related to the nozzle and waveform used to dispense the respective droplet and stored in a memory for use by a print controller to plan deposition of print material on a production substrate. The same controller can use the data from the droplet deposition analyzer 210 and the droplet flight analyzer 212 to determine firing parameters to be applied to nozzles of the printheads to achieve a droplet of a desired size landing at a desired location on a production substrate. The purge tool 214 is used to purge print material through nozzles of the printhead assembly 106 to remove deposits that can affect how the nozzles dispense print material. The purge tool 214 catches print material purged from the printhead assembly 106.

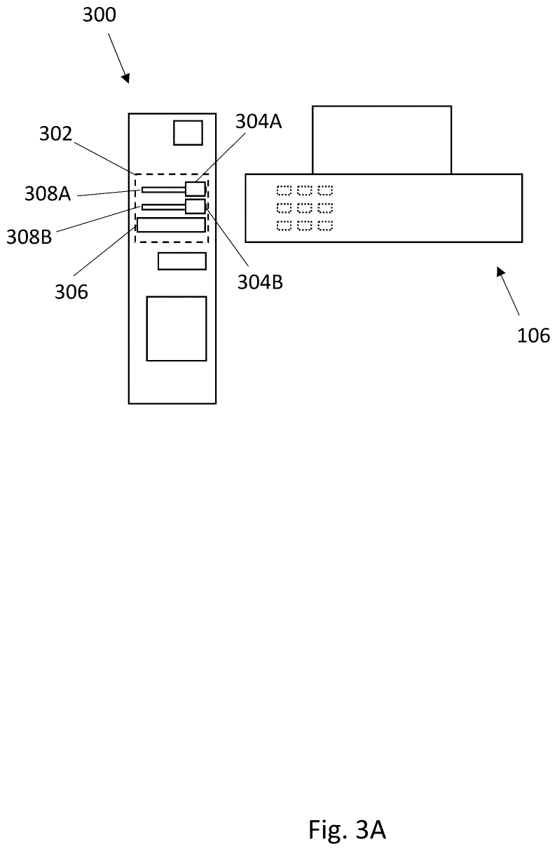

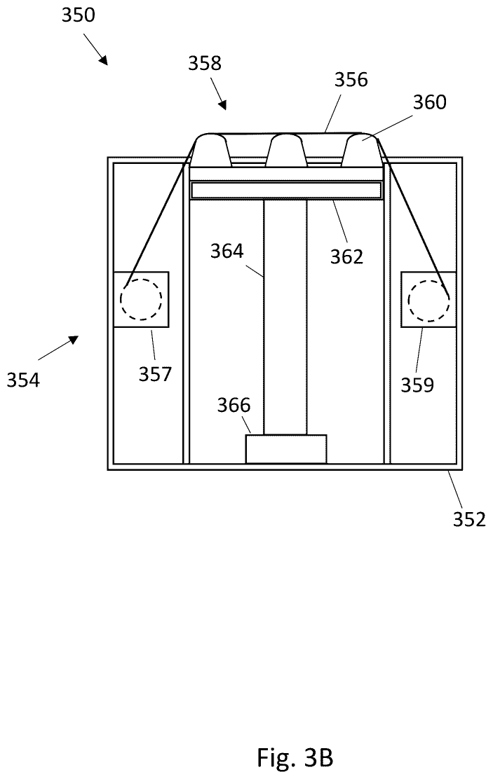

In other embodiments, two or more printhead cleaners can be grouped together in a cleaning unit that is part of a printhead management unit, and the small cleaners can be actuated to position the small cleaners for cleaning selected printhead groups. FIG. 3A is a schematic view of a printhead management unit 300 according to another embodiment. The printhead assembly 106 is also shown for reference and comparison. The printhead management unit 300 has a cleaning unit 302 with a plurality of printhead cleaners, each of which is sized to clean a printhead group or a plurality of printhead groups. The cleaning unit 302 has a first single-group cleaner 304A and a second single-group cleaner 304B. The cleaning unit 302 also has a multi-group cleaner 306. In this case, the printhead assembly 106 has three rows of three printhead groups, as described above, which could be any convenient configuration of printhead groups. In this case, the multi-group cleaner 306 is sized to clean a row of three printhead groups simultaneously.

Each of the two single-group cleaners 304A/B is movably attached to the printhead management unit 300, and is movable in a linear direction parallel to a longitudinal axis of the multi-group cleaner 306, and in this case parallel to the transverse direction of the printer that uses the printhead assembly 106 (see FIG. 1). Each of the two single-group cleaners 304A/B may be attached to the printhead management unit 300 by a linear actuator 308 (308A for the cleaner 304A and 308B for the cleaner 304B) that can move the single-group cleaner 304A/B from one edge of the cleaning unit 302 to an opposite edge of the cleaning unit 302. In this way, each single-group cleaner 304A/B can be positioned to contact and clean one printhead group in a row of printhead groups. The single-group cleaners 304A/B can be independently positioned, and can be moved at the same time or at different times, to clean a target printhead group. Using the cleaning unit 302, any combination of printhead groups of the printhead assembly 106 that needs cleaning can be cleaned in a minimum amount of time using an optimal combination of the multi-group cleaner 306 and the single-group cleaners 304A/B positioned and/or repositioned at times chosen to minimize the overall cleaning time.

In the embodiment of FIG. 3A, the cleaners 304A/B and 306 of the cleaning unit 302 can be selectively engaged with the printhead assembly 106 by adjusting elevation of the cleaning surfaces of the cleaners. FIG. 3B is a schematic elevation view of a printhead cleaner 350, according to one embodiment. The printhead cleaner 350 can be one of the single-group cleaners 304A/B or the multi-group cleaner 306. As the printhead assembly 106 is positioned over the cleaning unit 302 of FIG. 3A, the cleaning surfaces of any or all of the cleaners 304A/B and 306 can be elevated to contact one or more printhead groups of the printhead assembly 106, or can be lowered so that contact with a printhead group does not occur, by using a cleaner like the printhead cleaner 350.

The printhead cleaner 350 has a housing 352 that houses a mechanism 354 for providing a cleaning substrate 356 to a cleaning surface 358 at an extremity of the printhead cleaner 350. The cleaning substrate 356 is supported at the cleaning surface 358 by one or more cleaning supports 360 disposed at a working end of the printhead cleaner 350. In this case, there are three cleaning supports 360 in the printhead cleaner 350. The mechanism 354 generally unwinds the cleaning substrate 356 from a supply 357 toward the cleaning surface 358 and winds the cleaning substrate 356 to a gather 359. Each cleaning support 360 is an elongated member made of a pliable or spongy material to facilitate optimal contact force between the cleaning surface 358 and a nozzle surface of a printhead or printhead group. The cleaning supports 360 are disposed on a positioner 362 that positions the cleaning supports 360 in a direction toward or away from the printhead assembly 106 to provide contact between a nozzle surface and the cleaning surface 358 or clearance between the nozzle surface and the cleaning surface 358, depending on whether the printhead group needs cleaning. The positioner 362 includes a linear motion device 364 and a motor 366 to move the linear motion device 364. The linear motion device 364 extends to extend the cleaning surface 358 and retracts to retract the cleaning surface 358. Where the cleaners 304A/B and 306 of FIG. 3A are cleaners like the cleaner 350, the single-group cleaners 304A/B can be independently moved in a lateral direction and their cleaning surfaces can be independently actuated to change elevation, to move into or out of contact position for contacting printhead groups. Likewise, the cleaning surface of the multi-group cleaner 306 can be moved into or out of contact position for contacting printhead groups. In this way, any combination of printhead groups and cleaners can be brought into contact to optimize cleaning time for the printhead assembly 106, and the printhead assembly and cleaners can be positioned without undue contact.

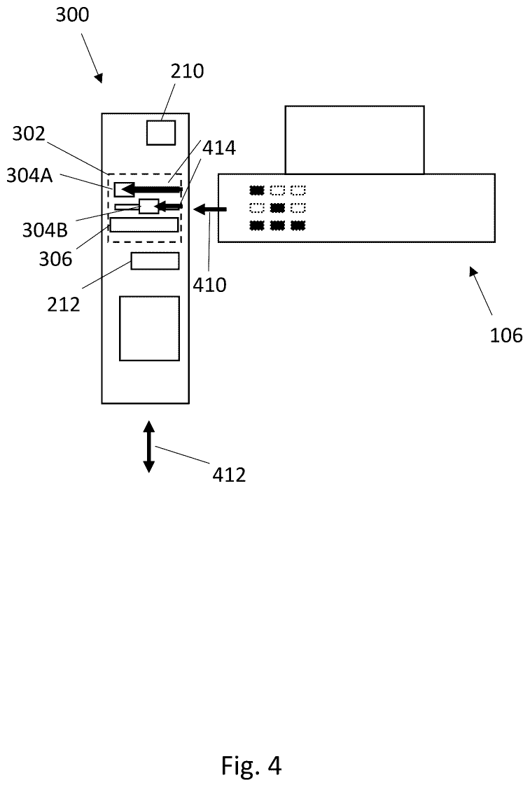

FIG. 4 is an activity diagram 400 illustrating a use of the cleaning unit 302 to clean printhead groups of the printhead assembly 106. In the activity diagram 400, printhead groups that need cleaning are shown in black, while printhead groups that do not need cleaning are shown in phantom. A test unit such as the droplet deposition analyzer 210 or the droplet flight analyzer 212 can be used to determine whether printhead groups need cleaning. Typically the test unit has a test substrate for dispensing droplets of print material from the nozzles of the printhead group and an imaging system to capture an image of the droplets and to determine properties of each nozzle from the droplets dispensed by the nozzle. The test unit can determine whether a droplet did not exit the nozzle and whether a droplet that exited the nozzle arrived on the test substrate according to any suitable tolerances or standards. Where any tolerances or standards are violated, or a droplet did not dispense from a nozzle, the test unit can determine that the printhead group in question needs cleaning.

The test unit has, or is in electronic communication with, a digital processing system that drives the image capturing and processing. The digital processing system is configured to control the imaging system to capture images of the droplets and to determine properties of the droplets and of the nozzles whence the droplets were dispensed. The digital processing system has a processor that can be configured to apply a threshold condition to determine that a printhead group needs cleaning. The threshold condition can be a number of nozzles that do not dispense droplets, a number of nozzles that dispense droplets in a manner that does not comply with a standard, or a combination thereof. Dispensed droplets can be non-compliant according to any or all of size, volume, or landing location in two dimensions. The threshold condition can be, or can depend on, a statistical treatment of nozzle performance data, such as an average or standard deviation of nozzle performance data. For example, a nozzle can be selected for cleaning based on deviation from a standard that is more than a variation multiple of the population of nozzle performance data (i.e. a statistical outlier). A threshold condition can also be applied to printheads or printhead groups, where a number of nozzles of a printhead or printhead group does not warrant cleaning the entire printhead group, or another threshold condition applies.

To perform a cleaning operation on tiles of the printhead determined to be in need of cleaning, the processing system can be configured to determine which of the printhead cleaners 304A/B or 306 are to be used for each tile that needs to be cleaned. The processing system can be configured to determine whether movement of the printhead assembly 106, the printhead management unit 300, and/or the cleaners 304A/B is needed to accomplish the cleaning operation. The processing system can also be configured to determine a use plan for the cleaners 304A/B and 306 that minimizes the time for cleaning the tiles that need cleaning. For example, the processing system can calculate time to clean for all possible uses of the cleaners 304A/B and 306 to clean the tiles and select the use plan with the lowest total time. The processing system can also be configured to perform a purge of all tiles, or the tiles that need cleaning, or some of the tiles that need cleaning based on the test information about the printheads.

When the use plan is determined, the printhead assembly 106 can be moved to an engagement position with the printhead management unit 300, as shown by arrow 410, by moving the printhead assembly 106 along its movement axis. The printhead management unit 310 also moves to an engagement position, as shown by arrow 412, along its movement axis that is generally orthogonal to the movement axis of the printhead assembly 106. When the printhead assembly 106 and the printhead management unit 300 are in engagement position, the cleaner 306, which is here configured to clean a row of print groups simultaneously, can be moved to contact with the row of print groups shown in FIG. 4 that need cleaning.

The cleaners 304A/B can also be moved along their respective movement axes to positions of engagement with the individual print groups that need cleaning in the other rows, as shown by arrows 414. In the configuration shown in FIG. 4, with this particular collection of printhead groups that need cleaning, and using a multi-group cleaner and movable single-group cleaners, the cleaning operation of FIG. 4 can be accomplished in one cleaning action. When the printhead assembly 106, printhead management unit 300, and cleaners 304A/B are in position, the printhead assembly can be moved toward the cleaners, or the cleaning surfaces of the cleaners can be moved toward the printhead assembly, or both to bring the nozzle surfaces that need cleaning into contact with the respective cleaners for cleaning.

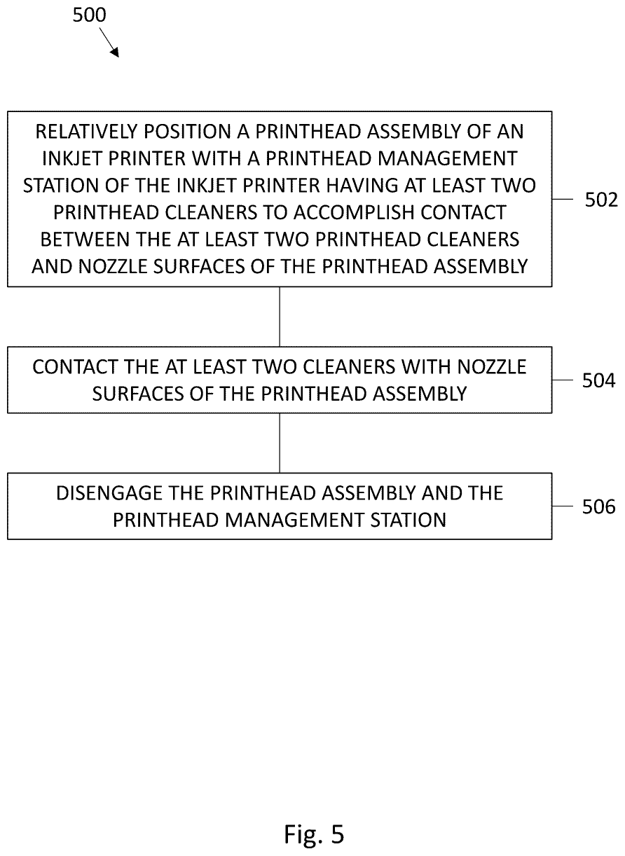

FIG. 5 is a flow diagram summarizing a method 500 according to one embodiment. The method 500 is a method of operating an inkjet printer having printheads arranged in a printhead assembly, each printhead having nozzles that dispense print material at a nozzle surface of the printhead. The method 500 can be performed using the apparatus described above. At 502, the printhead assembly of the inkjet printer and a printhead management unit of the inkjet printer having at least two printhead cleaners are relatively positioned to accomplish contact between the at least two printhead cleaners and nozzle surfaces of the printhead assembly. The printhead assembly may be moved, or the printhead management unit may be moved, or both, to bring the printhead assembly and the printhead cleaners into contact positions. A clearance between cleaning surfaces of the printhead cleaners and the nozzle surfaces of the printhead assembly is maintained while the printhead assembly and printhead management unit are positioned to avoid unwanted modes of contact between the cleaners and the nozzle surfaces of the printhead assembly.

At 504, the at least two cleaners are contacted with nozzle surfaces of the printhead assembly. Cleaning a printhead includes contacting a cleaning surface of a cleaner with the nozzle surface of the printhead to remove any deposits affecting how the nozzle dispenses print material. In the method 500, at least two cleaners are used, simultaneously or concurrently, to clean multiple printheads at once. The two cleaners are brought into contact with the nozzle surfaces by moving the cleaners toward the printhead assembly, by moving the printhead assembly toward the cleaners, or both. If necessary, the cleaners and the printhead assembly may be aligned prior to contact.

The cleaners used here have different sizes to contact different numbers of nozzle surfaces. The different sizes allow optimization of the cleaning process to use the cleaners in ways that minimize overall cleaning time. The printheads may be grouped into printhead groups, which may be printhead groups in some cases, for ease of maintenance. A cleaner of the at least two cleaners may have a cleaning surface with an areal extent that is large enough to contact the nozzle surface of only one printhead, of only one printhead group or tile encompassing multiple printheads, or of multiple printhead groups. Where multiple printhead groups need cleaning, using a cleaner with an areal extent that covers those printhead groups can be preferable to using a cleaner with areal extent that covers only one of the printhead groups, or only one nozzle surface of one printhead, because such a cleaner can clean multiple printhead groups in one cleaning action.

In one case, a first cleaner has an areal extent that covers one printhead group and a second cleaner has an areal extent that covers multiple printhead groups. In this case, the cleaning surface of the first cleaner is contacted with the nozzle surface of a printhead group that needs cleaning, while the cleaning surface of the second cleaner is, simultaneously or concurrently, contacted with the nozzle surfaces of a plurality of printhead groups, which may be adjacent, that need cleaning. The two cleaners concurrently clean the respective printheads in contact with the respective cleaning surfaces by movement of the printhead assembly while the cleaning surfaces are in contact with the nozzle surfaces. In this way, multiple printheads can be cleaned using one cleaning action.

At 506, the printhead assembly and printhead management unit are disengaged and repositioned to clean any other printheads that need cleaning, to perform other maintenance or diagnostic activity using the printhead assembly, or to return the printhead assembly to production. The printhead assembly and printhead management unit are relatively moved away from each other to establish clearance for repositioning (by moving the printhead assembly, the printhead management unit, or both), and one or both of the printhead assembly and the printhead management unit are repositioned so that the cleaners can be contacted with the other printheads that need cleaning. In many instances, where a cleaner that covers one printhead group is used with a cleaner that covers multiple printhead groups, it may be that the other printheads that need cleaning are in printhead groups that cannot be cleaned using the larger cleaner in one cleaning action. In such cases, the cleaner that covers one printhead group may be used to clean the remaining printheads one group at a time (in multiple cleaning actions of relatively positioning the printhead assembly and the printhead management unit, contacting the cleaning surface of the single-group printhead cleaner with the nozzle surfaces of the target printheads, performing a cleaning movement of the printhead assembly and/or the printhead management unit, and disengaging the cleaning surface from the nozzle surfaces).

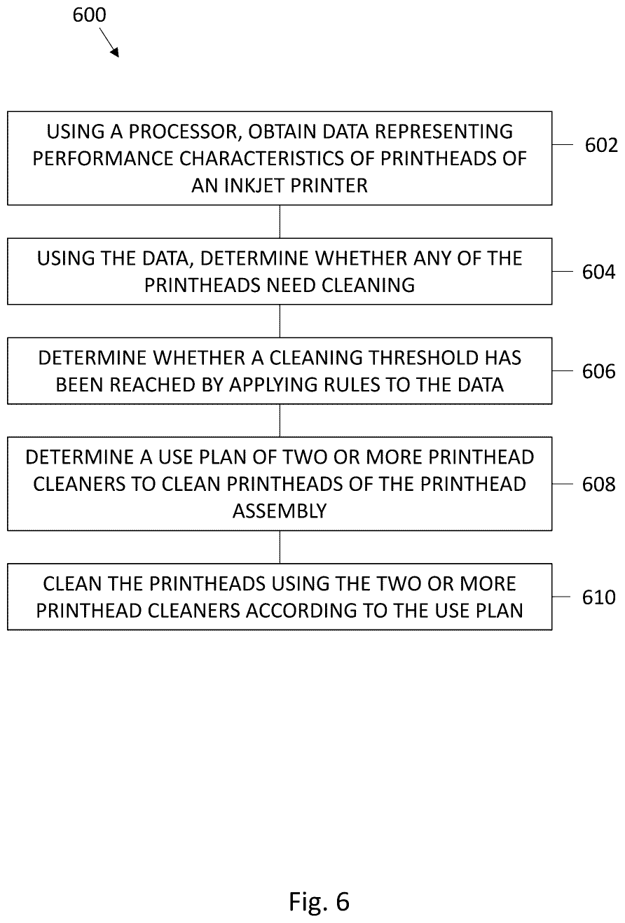

A controller having a digital processor can be used to control and optimize the process of cleaning printheads using at least two cleaners of different sizes. FIG. 6 is a flow diagram summarizing a method 600 according to another embodiment. The method 600 is a method of operating an inkjet printer, and can be practiced using any of the apparatus described above. At 602, a digital processing system is used to obtain data representing performance characteristics of printheads of an inkjet printer. The data can be used to determine whether nozzles of the printhead are performing according to a standard. The data are generated by testing deposition of the nozzles of the printheads using a droplet deposition analyzer or a droplet flight analyzer. The data can include droplet placement and droplet volume data. The data can include statistics like averages and standard deviations, or other distribution metrics, or the digital processing system can be configured to compute such statistics when the data is obtained.

At 604, a determination is made regarding whether any printheads need cleaning based on the data. For example, the data may indicate nozzles that failed to dispense print material during a test. The data may also indicate a droplet landing location that is off target by more than a threshold amount, or a droplet size diminished in volume by more than a threshold amount, or another printing anomaly associated with a nozzle of a printhead. The processor, or any processor, may be configured to apply predetermined rules and thresholds to the data to identify printheads that need cleaning.

At 606, rules are applied to the data to determine whether to institute a cleaning operation. The rules may include a threshold number of printheads and a threshold processing time impact of printhead non-conformance with standards. The processor, or any processor, can be configured to apply one or more rules to determine whether a cleaning threshold has been reached. For example, the processor may determine processing time impact, per workpiece, of printhead malfunction and compare that processing time impact to time required to conduct a cleaning operation. The time required to conduct the cleaning operation increases as the number of non-compliant printheads increases. The processor determines whether the processing time impact of printhead malfunction exceeds a threshold that is based on the time required to clean the printhead. The rules may include a selection criteria for selecting printheads out of tolerance for cleaning. While a printhead might be non-conforming, the printhead might not be sufficiently out of tolerance to trigger cleaning. For example, from the data representing nozzle performance, the processor can determine how many nozzles of each printhead are performing below a standard. The processor can compare the number to a threshold and classify printheads, and printhead groups, as needing cleaning or not needing cleaning. Where the processor determines the time required to perform a cleaning action, that time will be based on the printheads selected for cleaning.

The processor may also be configured with rules for predicting when a printhead might need cleaning, and may select the printhead for cleaning earlier than normal if the processor determines that the time the printhead will need cleaning is close. Thus, the processor may determine a number of printheads that have not yet reached a cleaning threshold but are within a time tolerance of an endpoint that would trigger cleaning of the printhead. The processor can be configured to predict a cleaning point of a printhead or printhead group, and to determine a remaining useful life of a printhead or printhead group. The processor can be further configured to compare the remaining useful life of each printhead or printhead group to a threshold value, and to identify printheads or printhead groups for cleaning where the remaining useful life is less that the threshold value.

At 608, the processor, or any processor, determines a use plan of two or more printhead cleaners to be used to clean printheads of the printhead assembly. The use plan may include movements of the printhead assembly between cleaning actions. Cleaning actions include bringing nozzle surfaces of the printhead assembly into contact with cleaning surfaces of cleaners, performing a cleaning movement of the printhead assembly and/or the cleaners, and disengaging the nozzle surfaces from the cleaning surfaces. The processor may be configured to optimize the number of cleaning actions with movements of the printhead and/or cleaners to minimize overall time to perform the cleaning operation.

The cleaners have different sizes to simultaneously clean different numbers of printheads or printhead groups. A first cleaner may have an areal extent that covers one group of printheads while a second cleaner may have an areal extent that covers a plurality of printhead groups. Thus, the first cleaner is a single-group cleaner and the second cleaner is a multi-group cleaner. The processor uses data representing the areal extent of the cleaners to determine whether groups of printheads can be simultaneously cleaned by the multi-group cleaner. The processor can be configured to determine an optimum use of the multi-group cleaner to minimize time for cleaning printheads selected for cleaning.

It should be noted that the processor may be configured to plan cleaning iteratively. Based on the printhead data, the processor may determine printheads needing cleaning now, printheads that need cleaning in the near future, and printheads that do not need cleaning. The processing may be configured to determine cleaning time and cleaner use plans for multiple cleaning scenarios in order to determine which cleaning scenario is optimal.

At 610, the printhead cleaners are used to clean the printhead assembly using the optimal use plan. The processor, or any processor, can control the printhead assembly and the cleaners to perform the optimized cleaning action using the optimal use plan. After the cleaning is performed, the printhead can be subjected to other maintenance or diagnostic procedures or can be returned to production.

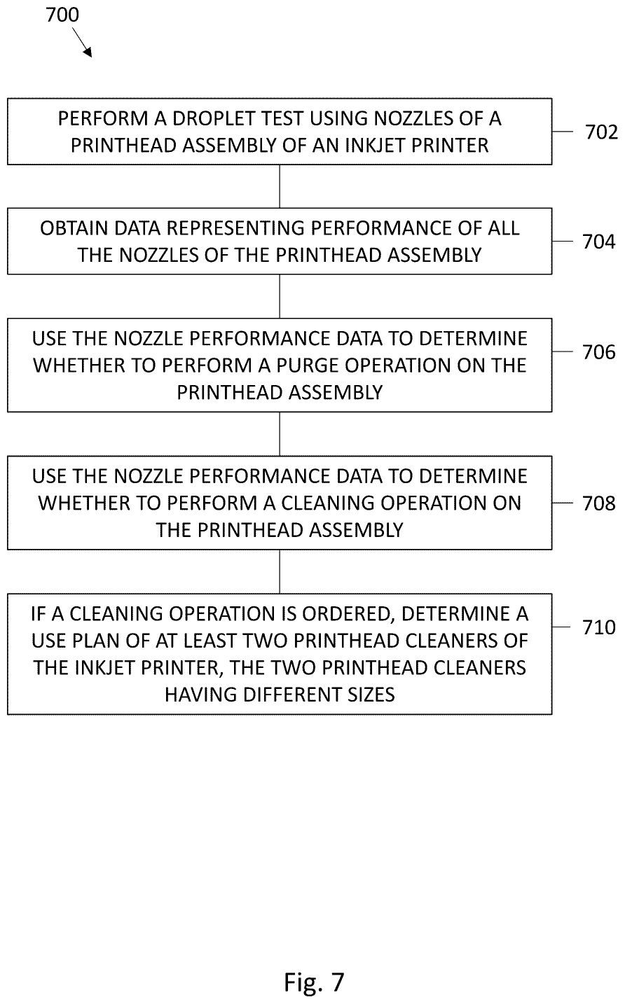

FIG. 7 is a flow diagram summarizing a method 700 according to another embodiment. The method 700 is a method of operating an inkjet printer, and can be performed using any of the apparatus described above. The inkjet printer has a printhead assembly with a plurality of printheads arranged in printhead groups, each printhead having a plurality of print nozzle. The inkjet printer also has a printhead management unit with at least two printhead cleaners of different sizes, a purge unit, and a test unit. At least one of the printhead cleaners has a size that is capable of cleaning at least two printhead groups in one cleaning action. The printhead assembly and the printhead management unit are generally movable in orthogonal directions to provide relative positioning of the printhead assembly and the printhead management unit for the two components to interact.

At 702, a droplet test is performed using nozzles of the printhead assembly and the test unit of the printhead management unit. The droplet test can be a deposition test or a droplet flight test. Droplets of print material are dispensed from some or all of the nozzles, and the droplet test creates data that represents performance of each respective nozzle in dispensing droplets. Typically, a controller having a digital processing system is configured to control the printhead assembly and the test unit to perform the droplet test. The test unit uses imaging components to capture images of the droplets. The controller controls the printhead assembly to dispense the droplets, and controls the test unit, directly or through a test controller of the cleaning unit or the printhead management unit, to capture the data. The data may include droplet placement data, droplet volume data, and/or droplet size data.

At 704, data representing performance of all the nozzles of the printhead assembly is obtained. This data may be, or may include, the data created at 702, and may include other data created at other times or by other means. The data also includes standards for comparison to determine whether nozzle performance meets the standard. The data may be obtained by the digital processing system of the controller, or by another digital processing system.

At 706, the data is used to determine whether to perform a purge operation, generally by comparison of the nozzle performance data to the standards. Rules may be applied to determine whether individual nozzles are sufficiently non-conforming to require a purge operation. Since the purge operation takes time and consumes print material, the purge operation is ordered when purging can substantially reduce the need for printhead cleaning. Such rules can be defined by applying statistical treatments to historical performance data, for example analyzing the relationship between purge intervals and performance improvement. Machine learning methods can be used to update rules and parameters automatically. The digital processing system of the controller, or another digital processing system, can be configured to determine whether to perform the purge operation.

If the purge is ordered, the controller can be configured to perform the purge operation by moving the printhead assembly and a purge unit of a printhead management unit of the inkjet printer into operative relationship to perform the purge, and by controlling nozzles of the printhead assembly to dispense print material to the purge unit. The purge may be performed using all nozzles of the printhead assembly, or using a portion of the nozzles. Depending on whether all nozzles are to be purged, and depending on the power budget of the printhead assembly, all nozzles, or all nozzles selected for purging, may be purged simultaneously, or the nozzles may be purged in groups. Print material is dispensed through nozzles being purged, and since there may be a large number of nozzles, purging groups of nozzles by turns may be the most effective way to purge in some cases. For example, the power surge necessary to electrically stimulate all nozzles at once or the capacity to deliver print material for dispensing from all nozzles simultaneously may be beyond hardware capacity to deliver. The digital processing system of the controller, or another digital processing system, may be configured to group nozzles for purging into groups subject to such constraints.

At 708, the data is used to determine whether to perform a cleaning operation. Similar to the purge operation, rules can be applied to determine whether individual nozzles need cleaning. The rules may include whether or not a purge operation is performed prior to the cleaning operation. For example, a rule may provide that a cleaning operation is performed on a nozzle where one or more performance parameters, in comparison to a standard, are within a first range and a purge has not been done. Another rule may provide that a cleaning operation is performed on a nozzle where the one or more performance parameters, in comparison to the standard, are within a second range and a purge has been done. Typically the second range will be more non-compliant than the first range. Another rule may provide that a cleaning operation is not performed unless the number of non-compliant nozzles (or printheads) exceeds a threshold. The rule may compare the loss of production capacity due to nozzle non-compliance with the capacity loss incurred to perform the cleaning operation. Another rule may predict a performance and/or capacity improvement from performing the cleaning operation. Production capacity can be lost if a nozzle is non-compliant and unusable because an inkjet printer may have a controller configured to choose optimal nozzles for dispensing print material, and unavailability of an optimum nozzle may require use of another nozzle at the cost of increased print time. All such rules may be defined using statistical treatments of data and/or physical models of the inkjet printer.

If a cleaning operation is ordered, at 710, the digital processing system of the controller, or another digital processing system, determines a use plan of the at least two printhead cleaners. Defining the use plan considers the printheads or printhead groups that need cleaning in the cleaning operation. The cleanable area, an accessible by the two or more cleaners in one cleaning action, is compared to the cleaning area, an area bounded by a smallest boundary encompassing all the printhead groups that need cleaning. If the cleanable area is smaller than the cleaning area, the cleaning area is divided into cleaning stages. The use plan includes movements of the printhead assembly, the printhead management unit, and optionally the individual cleaners of the cleaning unit and resolves cleaning stages and equipment movements that result in the lowest overall time to accomplish the cleaning operation. The digital processing system of the controller, or another digital processing system, can be configured to determine the use plan.

At 712, any use plan for a cleaning operation is executed by the controller signaling the printhead assembly and the printhead management unit to execute movements to bring the cleaners into contact with nozzle surfaces of the printhead assembly. The cleaning surfaces may be actuated to extend toward the printhead assembly or retract away from the printhead assembly to allow mutual positioning of cleaning surfaces and nozzle surfaces to make contact. If the cleaning operation is to be performed in two or more stages, after a first cleaning action, the controller controls the printhead assembly, printhead management unit, and optionally the individual cleaners to reposition to execute a second cleaning stage according to the use plan. The process repeats until all cleaning stages have been executed. The printhead assembly then returns to production.

While the foregoing is directed to embodiments of one or more inventions, other embodiments of such inventions not specifically described in the present disclosure may be devised without departing from the basic scope thereof, which is determined by the claims that follow.

1. An inkjet printer, comprising:
a substrate support;
a print support comprising a printhead assembly support disposed across the substrate support and supporting a printhead assembly; and
a printhead management unit disposed at one side of the substrate support, the printhead management unit comprising a first printhead cleaner having a first areal extent and a second printhead cleaner having a second areal extent different from the first areal extent.

2. The inkjet printer of claim 1, wherein the printhead assembly comprises a plurality of printhead groups having third areal extent, each pair of adjacent printhead groups having a fourth areal extent, and wherein the first areal extent is larger than the third areal extent and smaller than the fourth areal extent, and the second areal extent is larger than the fourth areal extent.

3. The inkjet printer of claim 1, wherein the printhead assembly comprises a plurality of printhead groups, each printhead group comprising a plurality of printheads, the first areal extent is large enough to clean only one printhead group, and the second areal extent is large enough to clean a plurality of printhead groups simultaneously.

4. The inkjet printer of claim 1, wherein the printhead assembly comprises a plurality of printhead groups arranged in multiple rows, and the second areal extent covers one row of printhead groups.

5. The inkjet printer of claim 1, wherein the first printhead cleaner is movable with respect to the second printhead cleaner.

6. The inkjet printer of claim 1, wherein the first printhead cleaner, the second printhead cleaner, or both have a cleaning surface that is actuated to change and elevation thereof.

7. A method of operating an inkjet printer, comprising:
obtaining data representing performance of nozzles of a plurality of printheads of the inkjet printer, the printheads arranged in groups, each group having a plurality of printheads;
determining, from the data, any groups that need cleaning due to nozzle performance that does not meet a standard;
defining a cleaning process comprising using a single-group cleaner of the inkjet printer, a multi-group cleaner of the inkjet printer, or both to clean the groups that need cleaning; and
using the single-group cleaner, the multi-group cleaner, or both according to the cleaning process.

8. The method of claim 7, wherein defining the cleaning process comprises determining a time to clean the groups that need cleaning.

9. The method of claim 7, wherein defining the cleaning process comprises determining, from the data, a number of nozzles, of each printhead, that do not meet a performance standard and comparing the number of nozzles to a threshold value.

10. The method of claim 9, wherein defining the cleaning process further comprises determining that a group does not need cleaning where the number of nozzles is less than the threshold value.

11. The method of claim 10, wherein defining the cleaning process further comprises predicting a future cleaning point for groups that do not need cleaning and determining a remaining useful life for the groups that do not need cleaning.

12. The method of claim 11, wherein defining the cleaning process comprises comparing the remaining useful life to a threshold and including groups for cleaning where the remaining useful life of the group is less than the threshold.

13. An inkjet printer, comprising:
a substrate support extending in a longitudinal direction of the inkjet printer;
a print support comprising a printhead assembly support disposed across the substrate support and supporting a printhead assembly that is movable along the printhead assembly support in a transverse direction of the inkjet printer; and
a printhead management unit disposed on a station support at one side of the substrate support, the printhead management unit comprising a first printhead cleaner having a first areal extent and a second printhead cleaner having a second areal extent different from the first areal extent, wherein the printhead management unit is movable along the station support in the longitudinal direction of the inkjet printer.

14. The inkjet printer of claim 13, wherein the first printhead cleaner is movable on the printhead management unit in the transverse direction of the inkjet printer.

15. The inkjet printer of claim 13, wherein the first printhead cleaner comprises a linear motion device to position a cleaning surface of the first printhead cleaner in a direction perpendicular to the longitudinal and transverse directions of the inkjet printer.

16. The inkjet printer of claim 14, wherein the printhead management unit further comprises a droplet placement analyzer, a droplet flight analyzer, or both, and further comprising a controller operatively coupled to the printhead assembly and the printhead management unit, the controller configured to control the droplet placement analyzer, the droplet flight analyzer, or both, to determine printheads of the printhead assembly that need cleaning based on data obtained using the droplet placement analyzer, the droplet flight analyzer, or both, and to control the printhead assembly and the printhead management unit to relatively position the printhead assembly and the printhead management unit to contact the first printhead cleaner, the second printhead cleaner, or both, with the printheads of the printhead assembly determined to need cleaning.

17. The inkjet printer of claim 16, wherein the first printhead cleaner, the second printhead cleaner, or both are movable with respect to the printhead management unit, and the controller is further configured to control the first printhead cleaner the second printhead cleaner, or both to move the first printhead cleaner, the second printhead cleaner, or both, with respect to the printhead management unit to position the first printhead cleaner, the second printhead cleaner, or both, with respect to one or more printheads determined to need cleaning.

18. The inkjet printer of claim 17, wherein the first printhead cleaner, the second printhead cleaner, or both comprises a linear motion device to position a cleaning surface of the first printhead cleaner, the second printhead cleaner, or both in a direction perpendicular to the longitudinal and transverse directions of the inkjet printer, and the controller is further configured to retract the cleaning surface of the first printhead cleaner, the second printhead cleaner, or both, before moving the printhead cleaner with respect to the printhead assembly.

19. The inkjet printer of claim 16, wherein the controller is further configured to predict a cleaning time for printheads of the printhead assembly based on data obtained from the droplet placement analyzer, the droplet flight analyzer, or both.

20. The inkjet printer of claim 16, wherein the printhead management unit further comprises a purge unit, and the controller is further configured to determine printheads or nozzles that need to be purged based on the data obtained using the droplet placement analyzer, the droplet flight analyzer, or both, and to control the printhead assembly and the printhead management unit to relatively position the printhead assembly and the purge unit to perform a purge of one or more of the printheads or nozzles that need to be purged.
